(19) United States
(12) Patent Application Publication
(10) Pub. No.: US 2009/0099922 A1
(43) Pub. Date: Apr. 16, 2009

(54) Advertising system and method

(76) Inventor: Andrew Paradies, Cincinnati, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 12/229,609

(22) Filed: Aug. 25, 2008

Related U.S. Application Data
(60) Provisional application No. 60/965,902, filed on Aug. 23, 2007.

(51) Int. Cl. G06Q 30/00; H04L 9/32; G06F 17/00; G06F 17/30

(52) U.S. Cl. 705/14; 726/27; 705/400; 705/27; 345/629; 707/104.1; 707/E17.044

(57) ABSTRACT

One aspect of the present invention provides a computer-implemented method of generating and sharing revenue between a hosting service and a digital content provider that includes the steps of: (a) transmitting digital works from the digital content provider to the hosting service; (b) associating an advertisement with the digital works such that the advertisement appears visually integrated within the digital works; (c) storing, by the hosting provider, the digital works and associated advertisement on a server device; (d) allowing third parties to electronically access the digital works and associated advertisement for display on a third party website; (e) generating revenue associated with at least one of sales of merchandise associated with the digital works and the advertisement associated with the digital works; and (f) distributing a first portion of the revenue to the hosting service and a second portion of the revenue to the digital content provider.

### CROSS-REFERENCE TO RELATED APPLICATIONS

This application claims the benefit of U.S. Provisional Application Ser. No. 60/965,902, entitled “ADVERTISING SYSTEM AND METHOD,” filed on Aug. 23, 2007, the disclosure of which is incorporated herein by reference.

### FIELD OF THE INVENTION

The present invention relates to an advertising system and method. Specifically, the present invention relates to digital content advertising and generating and sharing revenue associated with digital content advertisements.

### BACKGROUND OF THE INVENTION

Photography and graphic design have long been popular art forms for artists, including amateurs, hobbyists and professionals. With the increased presence and bandwidth of computer networks such as the Internet, more artists have utilized these networks to distribute, sell or otherwise share their photographic or graphic works in a digital format. By utilizing these computer networks, artists can now distribute their creations (or digital representations of their creations) with virtually anyone in the world.

In addition to artists, millions of amateur digital content providers now have a digital camera and an Internet connection. Digital cameras, digital image processing and the Internet have dramatically changed the photo-related services market, and have created entirely new ways for digital content providers to capture, edit, organize, find, share, create, print, preserve and sell digital works.

With the convenient digital distribution channel that the Internet provides, a digital content provider desires to store these digital works on a storage medium for quick and convenient distribution. Typically, a digital content provider stores digital works on a computer server that they own or on a computer server owned by a hosting service. Examples of hosting services include Shutterfly.com, flickr.com, and ImageShack.com. Hosting services typically provide storage, bandwidth, the ability to sell prints, and other services to digital content providers for no charge. These hosting services may also provide premium services such as increased amounts of storage and bandwidth for additional fees. However, no hosting service provider allows digital content providers to share in revenue generated from advertising and merchandise sales. Therefore, a need exists for a system and method of storing and distributing digital works while sharing generated revenue with the digital work provider.

### SUMMARY OF THE INVENTION

Embodiments of the present invention provide a system and method of storing and distributing digital works while sharing generated revenue with the digital work provider.

It is a first aspect of the present invention to provide a computer-implemented method of generating and sharing revenue between a hosting service and a digital content provider that includes the steps of: (a) transmitting digital works from the digital content provider to the hosting service; (b) associating an advertisement with the digital works such that the advertisement appears visually integrated within the digital works; (c) storing, by the hosting provider, the digital works and associated advertisement on a server device; (d) allowing third parties to electronically access the digital works and associated advertisement for display on a third party website; (e) generating revenue associated with sales of merchandise associated with the digital works and/or the advertisement associated with the digital works; and (f) distributing a first portion of the revenue to the hosting service and a second portion of the revenue to the digital content provider.

In one embodiment of the first aspect, the transmitting step includes the additional step of: providing assent, by the digital content provider, to allow the hosting provider to store, display and generate revenue associated with the digital works. In another embodiment, the transmitting step includes the step of: licensing, by the digital content provider to the hosting service, rights associated with the digital works, where the rights include the right to use, store, distribute, display and/or create derivative works. In another embodiment, the advertisement appears visually integrated within the digital works by implementing a superimposing technique, an overlaying technique, an embedding technique and/or a combination technique.

In another embodiment of the first aspect, the method further includes the step of: prior to the allowing step, associating attributes with the digital works, wherein the attributes include tags, classifications, categorizations, and/or descriptions. In another embodiment, the advertisement includes subject matter related to the attributes.

In yet another embodiment of the first aspect, the generating revenue step includes the steps of: tracking each accessing of the digital work and associated advertisement, and determining the first portion and the second portion of the revenue based, at least in part, on the results of the tracking step. In one embodiment, the tracking step includes logging in a log file each accessing of the digital work and associated advertisement. In another embodiment, the generating revenue step includes the steps of: tracking each sale of merchandise associated with the digital works, and determining the first portion and the second portion of the revenue based, at least in part, on the results of the tracking step. In another embodiment, the tracking step includes logging in a log file each sale of merchandise associated with the digital works. Yet another embodiment includes the additional step of: determining a suggested merchandise price based, at least in part, on the results of the tracking step, previous merchandise sales for similar merchandise and merchandise sales by other digital content providers.

It is a second aspect of the present invention to provide a system for generating and sharing revenue between a hosting service and a digital content provider, including digital works provided by the digital content provider, a server device adapted to store the digital works and further adapted to transmit the digital works upon receiving an electronic request to transmit the digital works, a tracking component adapted to track a transmission information related to the transmission of the digital works and/or request information related to the electronic requests, an advertisement component adapted to visually integrate advertisements into the digital works, and a revenue distribution component adapted to distribute the revenue to the hosting service and/or the digital content provider. Revenue is generated by users accessing the advertisements and/or users purchasing merchandise associated with the digital works.

In one embodiment of the second aspect, the advertisement component visually integrates the advertisements within the digital works by implementing a superimposing technique, an overlaying technique, an embedding technique and/or a combination technique. In another embodiment, the system also includes an attribute component adapted to associating attributes with at least one of the digital works, where the attributes include tags, classifications, categorizations, and/or descriptions.

It is a third aspect of the present invention to provide a computer-implemented method of generating and sharing revenue between a hosting service and a digital content provider, that includes the steps of: (a) transmitting digital works from the digital content provider to the hosting service; (b) embedding an advertisement into the digital works such that the advertisement appears visually integrated within the digital works; (c) storing, by the hosting provider, the digital works and embedded advertisement on a server device; (d) linking, on a third party website, to one of the digital works; (e) upon a user clicking on the digital work on the third party website, directing the user to a website offering merchandise associated with the digital work for sale; (f) completing the sale of the merchandise associated with the digital work; and (g) distributing a first portion of the sale proceeds to the hosting service and a second portion of the sale proceeds to the digital content provider.

From the foregoing disclosure and the following detailed description of various preferred embodiments it will be apparent to those skilled in the art that the present invention provides a significant advance in the art of digital content advertising systems and methods. Additional features and advantages of various preferred embodiments will be better understood in view of the detailed description provided below.

### BRIEF DESCRIPTION OF THE DRAWINGS

The present invention will be understood and appreciated more fully from the detailed description in conjunction with the following drawings in which:

FIG. 1 is a diagram of an exemplary embodiment of the present invention; and

FIGS. 2a and 2b depict exemplary embodiments of the present invention.

### DETAILED DESCRIPTION

It should be understood that the following detailed description of exemplary embodiments of the invention are exemplary in nature and are not intended to constitute limitations upon the invention. It is also to be understood that variations of the exemplary embodiments contemplated by one of ordinary skill in the art shall concurrently fall within the scope and spirit of the invention. Although certain aspects of the exemplary embodiments are shown in more detail, some features within the purview of one skilled in the art may have been omitted for the sake of clarity and brevity.

As used herein, digital works 30 shall include, without limitation, photography, pictures, graphic designs, pictorial representations, movies, videos, animations, audio works, visual media and/or other digital works. A digital content provider or digital content providers shall include any person or entity owning, possessing, uploading and/or providing digital works 30.

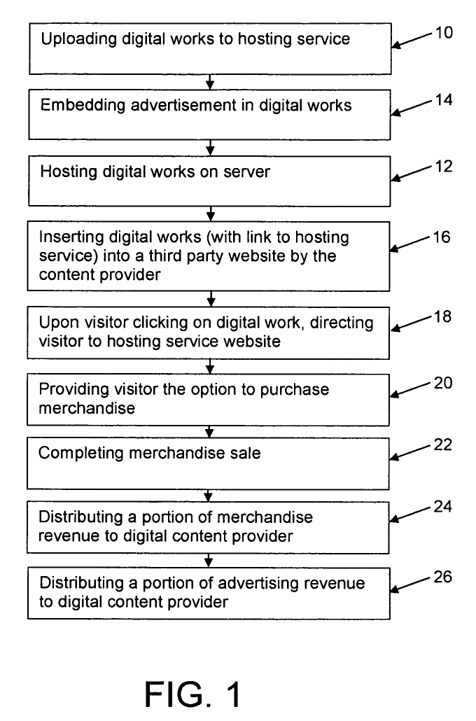

One embodiment (as depicted in FIG. 1) is directed to a method of generating and sharing revenue with digital content providers. This system and method may allow a digital content provider to transmit 10 and store 12 digital works 30 on a hosting service. The hosting service may allow the digital content provider to access the digital works 30 for use, distribution or linking 16 on websites such as blogs, personal or professional webpages and social networking webpages. When a visitor navigates to the digital content provider's website, the visitor views the digital work 30. The visitor may then click on (e.g. activate or actuate) the digital work 30 via a computer mouse or other input device. Upon clicking on the digital work 30, the visitor's browser is directed 18 to the hosting service website. At the hosting service website, the visitor may view the digital work 30 and other digital works 30 created by the digital content provider or other digital content providers. The visitor may purchase 20 physical prints of the digital work 30, a license to use or reproduce the digital work 30 and/or other associated products related to the digital work 30. The purchase price for these products may be set by the digital content provider, set by the hosting service, or a combination of both. Upon completing 22 the sale of merchandise, a portion of the merchandise sale revenue is distributed 24 to the digital content provider. Further, a portion of the merchandise sale revenue is distributed 26 to the hosting service. Additionally, the hosting service website displaying the digital work 30 may include advertisements 14 such as banner advertisements. These banner advertisements may generate advertising revenue when a visitor clicks on them. A portion of the revenue from products sold and/or advertising revenue may then be shared between the hosting service and the digital content provider.

One embodiment is directed to a system and method of generating advertisements 32 embedded or positioned within digital works 30. In an exemplary embodiment of this aspect, the advertisements 32 may be overlaid on, superimposed on or embedded within the digital work 30 after the digital content provider uploads the digital work 30 to the hosting service website. The advertisement 32, the digital work 30, or both may be associated with a link to the hosting service website or to a website associated with the advertisement 32. Upon clicking on the advertisement 32 or the digital work 30, a visitor is directed to the hosting service website or the website associated with the advertisement 32. A mechanism for tracking or logging each time a visitor clicks on the advertisement 32 or the digital work 30 is also provided. This tracking or logging mechanism helps advertisers and/or the hosting service determine how much advertising revenue should be distributed. A portion of the advertising revenue may be shared between the hosting service and the digital content provider.

In another embodiment, a system and method of generating and sharing revenue with digital content providers is provided. This system and method allows a hosting service and a digital content provider to share revenue generated from advertising and merchandise sales. In this embodiment, the digital content provider uploads or transmits digital works 30 or representations of digital works 30 onto the hosting service servers. The hosting service stores the digital works 30 on servers owned or maintained by the hosting service. A digital content provider may incorporate a digital work 30 on a website such as a blog, personal or professional webpages, social networking webpages, or any other website. One example of such incorporation includes adding code to a Hypertext Markup Language (or html) webpage. However, any computer-readable language capable of displaying a webpage may also be used. This code may embed a link to the digital work 30 in the html webpage to display the digital work 30 to visitors. This code may also allow the digital work 30 to be clickable or executable such that when a visitor clicks or executes the digital work 30 via a user input device, the visitor's browser is directed to the hosting service website. In one embodiment, the visitor's browser is directed to a hosting service-hosted webpage associated with the digital content provider and may display one or more of the digital content provider's digital works 30.

In addition to displaying one or more of the digital content provider's digital works 30, the hosting service website may provide the ability for visitors to view and purchase one or more merchandise item associated with the one or more digital works 30. Examples of such merchandise may include, without limitation, licenses to use or display the digital work 30, physical prints or reprints in various sizes and on various substrates, calendars, display books, food or beverage holders and/or other similar merchandise. In one embodiment, physical prints or reprints may be available for purchase with or without advertisements 32 embedded. In this embodiment, the prints without advertisements may be more expensive than prints with advertisements 32.

When a visitor purchases merchandise from the hosting service website, a portion of the revenue from the purchase may be distributed to the hosting service and a portion may be distributed to the digital content provider. In one embodiment, the purchase price for a merchandise item is established by the digital content provider. In another embodiment, the hosting service may require that a minimum portion of revenue (such as a minimum percent or established fee) be distributed to the hosting service. In another embodiment, the hosting service may require that a digital content provider charge a minimum price for a merchandise item.

In addition to merchandise revenue, advertising revenue may also be generated and distributed between the hosting service and digital content provider. Advertisers or their agents may pay the hosting service to include advertisements 32 of various products or services. These advertisements 32 may be implemented as watermarked ads, superimposed ads, banner ads, interstitial ads, floating ads, wallpaper ads, expanding ads or any other ad format known in the art. Advertisers or their agents may calculate the amount owed to the hosting service in a variety of ways. Calculations may be based on the number of visitors viewing the advertisements 32, while others may be based on the number of visitors clicking and navigating to the advertiser's website. These may include calculations based on cost per thousand, cost per visitor, cost per click, cost per action or any other method known in the art. Any of these methods or any combination of these methods may be implemented to determine or calculate advertising revenue. Regardless of what method is used to determine advertising revenue associated with a digital content provider, the distribution of revenue may be determined based on a fixed structure, a predetermined percentage, or a combination of both.

In one embodiment, the hosting service website may provide the ability for visitors to view and purchase merchandise associated with the one or more digital works 30 from other digital content providers. The hosting service website may display a link to other digital works 30 or digital content providers that may be of interest to the digital content provider. For example, a visitor is viewing Digital Work #1 created by User X. The hosting service website may display a link to Digital Work #2 created by User Y because the subject matter of Digital Works #1 and #2 are of a similar nature, such as a depiction of dogs. The visitor may be interested in viewing or purchasing merchandise associated with Digital Work #2. If so, the visitor may click on the link to Digital Work #2 and is directed to a webpage displaying User Y's digital works including Digital Work #2 and associated merchandise.

In another embodiment, revenue from merchandise sales and/or advertising may be distributed among the hosting service, the digital content provider, and a third party publisher. A third party publisher may be any third party website such as a blog or social networking website. Third party publishers such as blogger.com, MySpace.com, Facebook.com, and twitter.com provide a digital content provider a venue for creating a personal webspace. A digital content provider may add digital works 30 hosted by the hosting service to the personal webspace. When a visitor clicks on the digital work 30, the visitor's browser is directed to the hosting service website. In this case, any advertising or merchandise revenue generated may be distributed among the hosting service, the digital content provider, and a third party publisher. The distribution of revenue may be determined based on a fixed structure, a predetermined percentage, or a combination of both.

Prior to or during uploading or transmitting digital works 30 to the hosting service, the digital content provider and hosting service agree to a license for use of the digital works 30. The digital content provider may be required to affirmatively accept the terms of the license prior to uploading the digital work 30 to the hosting service servers. Alternatively or additionally, the digital content provider may be required to accept the terms of the license when creating an account with the hosting service. Such a license may include a right to allow third parties to link to the digital work 30 for display on third party websites. An additional right may include the right to allow third parties to copy the digital work 30 to third party servers, while still linking the digital work 30 back to the hosting service website. Additionally, the license may include the right to alter the digital work 30 to superimpose, overlay, or include advertisements (permanent or temporary) over a portion of the digital work 30. Also, this license may include terms regarding the revenue distribution structure for distributing revenue between parties.

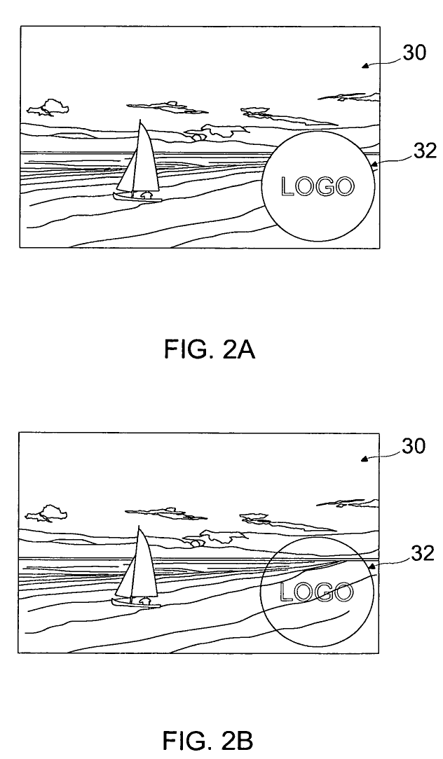

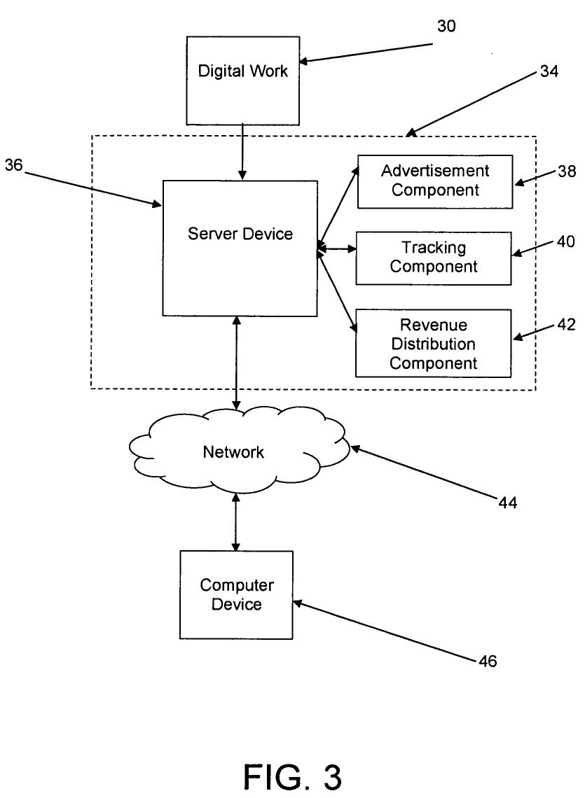

In another exemplary embodiment, a system and method of generating advertisements 32 embedded or positioned within digital works 30 is provided. The advertisements 32 may be superimposed, overlaid, watermarked, or otherwise incorporated within the digital work 30. FIGS. 2a and 2b depict exemplary embodiments of the present invention. In FIGS. 2a and 2b, a company logo advertisement 32 is positioned within the digital work 30. The digital work 30 with associated advertisement 32 shall be referred to as a “Picture In Picture” or PIP. The hosting service may automatically generate the PIP when a digital content provider uploads the digital work 30 onto the hosting service server or thereafter. The advertisement 32, the digital work 30, or both may be associated with a link to the hosting service website or to a website associated with the advertisement 32. Upon clicking any portion of the PIP, a visitor is directed to the hosting service website or the website associated with the advertisement 32. A mechanism for tracking or logging each time a visitor clicks on the PIP is also provided. This tracking or logging mechanism helps advertisers and/or the hosting service determine how much advertising revenue should be distributed. This tracking or logging mechanism may be a log file or any other type of mechanism for recording, tracking or logging data. A portion of the advertising revenue may be shared between the hosting service and the digital content provider. This distribution of revenue may be determined based on a fixed structure, a predetermined percentage, or a combination of both.

The PIP may be implemented in many ways. In an exemplary embodiment, the PIP is implemented by using html and Cascading Style Sheets (css). However, any other known computer language capable of overlaying, superimposing, or embedding an advertisement 32 on a digital work 30 may be implemented. In one embodiment, the advertisement 32 in the PIP may include a logo, slogan, mascot, trademark or other text or graphical depiction. The advertisement 32 may be various sizes and may also be animated to help draw attention to it. The advertisement 32 may be located in a predetermined position such as the bottom, top, right, left, center, or a combination thereof. In one embodiment, the advertisement 32 may be different shapes such as a circle, oval, square, rectangle, triangle, or other shape. In another embodiment, the advertisement 32 may be moved within the digital work 30 by a visitor. In another embodiment, the advertisement 32 may be positioned such that the advertisement 32 appears to be a part of the original digital work 30. For example, in a digital work 30 that includes a representation of a billboard, an advertisement 32 may be placed such that it appears that the billboard physically includes the contents of the advertisement 32. In one embodiment, attributes such as size, position and shape may be chosen by the digital content provider.

The digital content provider may also have the ability to allow or disallow advertisements 32 to be included in their digital works 30. If a digital content provider chooses to disallow advertisements 32 to be included in their digital works 30, the digital content provider may not be entitled to any distribution of advertising revenue. In that case, the hosting service may still track or log how many clicks or views the digital work 30 received. This tracking or logging may be useful in reporting to the digital content provider how much revenue was not generated because of the disallowed advertisements.

In another exemplary embodiment, a system and method of determining a suggested pricing plan for sales of merchandise associated with digital works 30 is provided. This suggested pricing plan may be designed to maximize a digital content provider's merchandise sales. Such a determination may be made based on several criteria or data points. In an exemplary embodiment, the determination is made based, at least in part, on merchandise sales by other digital content providers and previous sales by the digital content provider. In another embodiment, the determination is made based, at least in part, on sales of digital content with similar subject matter.

In another embodiment, digital works 30 may be categorized utilizing attributes associated with the digital works 30. Attributes may include tags, descriptions and/or classifications. Such attributes may be provided by the digital content provider, generated by the hosting service, generated by a software application, or generated by visitors. For example, the digital works 30 may be categorized based on the WordNet semantic lexicon. WordNet is an open source software project created by Princeton University that relates category sets and subsets in a hierarchy. By implementing the WordNet system, digital works 30 may be categorized into a variety of categories and subcategories based on content or other attribute. A visitor has the ability to search within a specific category and/or subcategory. In another embodiment, a channel of associated digital works is provided. This channel may be a feed, widget, code snippet or webpage that displays digital works 30 with the same or similar attributes. For example, an airplane channel may compile and display all digital works 30 associated with an airplane attribute. A user or visitor may be able to add the feed, widget or code to a personal webspace or other webpage. This aspect allows for advertising that is targeted to a specific audience. Ideally, targeted advertisements increase the amount of clicks on that advertisement, thus increasing the amount of advertising revenue generated.

It should be understood that the systems and methods described herein may be operating on a single computer server device, a networked group of computer servers, or any other networked computer device or computerized device or system of computer devices or computerized devices on which the tools and/or processes of the exemplary embodiments may operate.

In one exemplary embodiment (as depicted in FIG. 3), the system may include one server device 36 that electronically communicates with an advertisement component 38, a tracking component 40 and a revenue distribution component 42. In such system, the hosting service 34 may manage each of the server device 36 the advertisement component 38, the tracking component 40 and the revenue distribution component 42. The digital work 30 may be stored on the server device 36 and transmitted to a requesting computer device 46 (for example). A request to access the digital work 30 may be transmitted over a network 44 (such as a local network, the Internet, or other similar networks). In this system, the advertisement component 38 visually integrates advertisements into the digital works 30. The tracking component 40 tracks or logs transmission information related to the transmission of the digital works 30 and request information related to requests for the digital works 30 from the computer device 46. The revenue distribution component 42 distributes the revenue generated by users accessing the advertisements and/or users purchasing merchandise associated with the digital works 30 to the hosting service 34 and the digital content provider.

Various embodiments provide for the devices, components and/or steps to be implemented as software, hardware, or a combination thereof. Further, the devices, components and/or steps described herein need not be performed by separate tasks or processes, or be implemented in physically separate hardware or software components.

The apparatuses, uses, and methods disclosed herein have been described without reference to specific hardware. However, the apparatuses, uses, and methods disclosed herein have been described in a manner sufficient to enable persons of ordinary skill in the art to readily adapt commercially available hardware as may be needed to reduce any of the embodiments of the present invention to practice without undue experimentation.

Following from the above description and invention summaries, it should be apparent to those of ordinary skill in the art that, while the methods and apparatuses herein described constitute exemplary embodiments of the present invention, it is to be understood that the inventions contained herein are not limited to the above precise embodiment and that changes may be made without departing from the scope of the invention. Likewise, it is to be understood that it is not necessary to meet any or all of the identified advantages or objects of the invention disclosed herein in order to fall within the scope of the invention, since inherent and/or unforeseen advantages of the present invention may exist even though they may not have been explicitly discussed herein.

What is claimed is:

1. A computer-implemented method of generating and sharing revenue between a hosting service and a digital content provider, comprising the steps of:
transmitting one or more digital works from the digital content provider to the hosting service;
associating an advertisement with the one or more digital works such that the advertisement appears visually integrated within the one or more digital works;
storing, by the hosting provider, the one or more digital works and associated advertisement on a server device;
allowing third parties to electronically access the one or more digital works and associated advertisement for display on a third party website;
generating revenue associated with at least one of sales of merchandise associated with the one or more digital works and the advertisement associated with the digital works; and
distributing a first portion of the revenue to the hosting service and a second portion of the revenue to the digital content provider.

2. The method of claim 1, wherein the transmitting step includes the step of:
providing assent, by the digital content provider, to allow the hosting provider to store, display and generate revenue associated with the one or more digital works.

3. The method of claim 1, wherein the transmitting step includes the step of:
licensing, by the digital content provider to the hosting service, rights associated with the digital works, the rights including at least one of the right to use, store, distribute, display and create derivative works.

4. The method of claim 1, wherein the advertisement appears visually integrated within the one or more digital works by implementing at least one of a superimposing technique, an overlaying technique, an embedding technique and a combination technique.

5. The method of claim 1, further comprising the step of:
prior to the allowing step, associating one or more attributes with at least one of the digital works, wherein the one or more attributes include at least one of tags, classifications, categorizations, and descriptions.

6. The method of claim 5, wherein the advertisement includes subject matter related to the one or more attributes.

7. The method of claim 1, wherein the generating revenue step includes the steps of:
tracking each accessing of the digital work and associated advertisement; and
determining the first portion and the second portion of the revenue based, at least in part, on the results of the tracking step.

8. The method of claim 7, wherein the tracking step includes logging in a log file each accessing of the digital work and associated advertisement.

9. The method of claim 1, wherein the generating revenue step includes the steps of:
tracking each sale of merchandise associated with the one or more digital works; and
determining the first portion and the second portion of the revenue based, at least in part, on the results of the tracking step.

10. The method of claim 7, wherein the tracking step includes logging in a log file each sale of merchandise associated with the one or more digital works.

11. The method of claim 9, further comprising the step of:
determining a suggested merchandise price based, at least in part, on the results of the tracking step, previous merchandise sales for similar merchandise and merchandise sales by other digital content providers.

12. A system for generating and sharing revenue between a hosting service and a digital content provider, comprising:
one or more digital works provided by the digital content provider;
a server device adapted to store the one or more digital works and further adapted to transmit the one or more digital works upon receiving an electronic request to transmit the one or more digital works;
a tracking component adapted to track at least one of transmission information related to the transmission of the one or more digital works and request information related to the electronic requests;
an advertisement component adapted to visually integrate one or more advertisements into one or more of the digital works, wherein revenue is generated by at least one of users accessing the one or more advertisements and users purchasing merchandise associated with the one or more digital works; and
a revenue distribution component adapted to distribute the revenue to at least one of the hosting service and the digital content provider.

13. The system of claim 12, wherein the advertisement component visually integrates the one or more advertisements within the one or more digital works by implementing at least one of a superimposing technique, an overlaying technique, an embedding technique and a combination technique.

14. The system of claim 12, further comprising:
an attribute component adapted to associating one or more attributes with at least one of the one or more digital works, wherein the one or more attributes include at least one of tags, classifications, categorizations, and descriptions.

15. A computer-implemented method of generating and sharing revenue between a hosting service and a digital content provider, comprising the steps of:
transmitting one or more digital works from the digital content provider to the hosting service;
embedding an advertisement into the one or more digital works such that the advertisement appears visually integrated within the one or more digital works;
storing, by the hosting provider, the one or more digital works and embedded advertisement on a server device;
linking, on a third party website, to one of the digital works;
upon a user clicking on the digital work on the third party website, directing the user to a website offering merchandise associated with the digital work for sale;
completing the sale of the merchandise associated with the digital work; and
distributing a first portion of the sale proceeds to the hosting service and a second portion of the sale proceeds to the digital content provider.
